(19) United States
(12) Patent Application Publication
(10) Pub. No.: US 2010/0061598 A1
(43) Pub. Date: Mar. 11, 2010

(54) APPARATUS AND METHOD FOR RECOGNIZING SUBCUTANEOUS VEIN PATTERN

(75) Inventor: Keunjoo Seo, Seoul (KR)

Correspondence Address: THE NATH LAW GROUP, 112 South West Street, Alexandria, VA, 22314, US

(73) Assignee: INNOZEST INC., Seoul (KR)

(21) Appl. No.: 12/451,279

(22) PCT Filed: May 7, 2008
(86) PCT No.: PCT/KR2008/002571

§ 371 Date: Nov. 4, 2009

(30) Foreign Application Priority Data
May 7, 2007 (KR) 10-2007-0044327

(51) Int. Cl. G06K 9/00

(52) U.S. Cl. 382/115

(57) ABSTRACT

The present invention relates to an apparatus and a method for recognizing a subcutaneous vein pattern. More particularly, the present invention is directed to an apparatus for recognizing a subcutaneous vein pattern comprising: a light illuminator having an NIR (near infrared light) emitting device; an image acquisitor having a lens and an image sensor which converts light reflected from subcutaneous vein into an image signal; a microprocessor which adjusts an illuminating intensity of the light illuminator and a light receiving sensitivity of the image acquisitor according to an illuminance estimated from the image signal; and a displayer which display image signals received from the microprocessor.

### TECHNICAL FIELD

The present invention relates to an apparatus and a method for recognizing a subcutaneous vein pattern. More particularly, the present invention is directed to an apparatus for recognizing a subcutaneous vein pattern comprising: a light illuminator having an NIR (near infrared light) emitting device; an image acquisitor having a lenz and an image sensor which converts light reflected from subcutaneous vein into an image signal; a microprocessor which adjusts an illuminating intensity of the light illuminator and a light receiving sensitivity of the image acquisitor according to an illuminance estimated from the image signal; and a displayer which display image signals received from the microprocessor.

### BACKGROUND ART

Korean patent No. 10-0438418 discloses a method and system for verification of blood vessel-patterns of the back of the hand for person identification which comprises: photographing an original image of a user's hand by using a camera when a hand and fingers of the user are fixed on a handle; conceiving a movement of the user's hand by means of an input location of the hand, successive input images of the hand, and a grey scale distribution to compensate the location of the hand; and comparing the blood vessel-pattern of the back of the user's hand with a blood vessel-pattern stored in a data base to indentifying the user.

Korean patent No. 10-0259475 discloses a method for the identification of individuals using the pattern of blood vessels which comprises: selecting a certain area from converted image data of a back of a hand; high pass filtering data of the selected area out of the image data; binarizing the filtered data; removing noise from the binarized data to extract the distribution pattern of blood vessels; obtaining a distribution characteristic which represents branch points of the distribution pattern of blood vessels, number of branches of the branch point, and a relation of connection of the branches, from the extracted distribution pattern of blood vessels; comparing the obtained distribution pattern of blood vessels with the stored distribution pattern of blood vessels; choosing a reference position of the extracted distribution pattern of blood vessels from the obtained distribution characteristic; superposing the chosen reference position of the extracted distribution pattern of blood vessels with the reference position of the stored distribution pattern of blood vessels to compare the extracted distribution pattern with the stored distribution pattern; and identifying the individual based on the comparison of the two distribution patterns.

U.S. Pat. No. 6,230,046 discloses a system and method for enhancing visualization of veins, arteries or other subcutaneous natural or foreign structures of the body and for facilitating intravenous insertion or extraction of fluids, medication or the like in the administration of medical treatment to human or animal subjects are described which comprise a light source for illuminating or transilluminating the corresponding portion of the body with light of selected wavelengths and a low-level light detector such as an image intensifier tube (including night vision goggles), a photomultiplier tube, photodiode or charge coupled device, for generating an image of the illuminated body portion, and optical filter(s) of selected spectral transmittance which can be located at the light source(s), detector, or both.

U.S. patent application Ser. No. 11/173,452 discloses an imaging system illuminates an object with infrared light to enhance visibility of buried structure beneath the surface of the object, and projects a visible light image of the buried structure onto the surface of the object.

U.S. patent application Ser. No. 10/899,518 discloses a portable vein locating device includes one or more infrared illuminators for transmission through a patient's skin of infrared light and a vein imaging module for determining the location of a vein beneath the skin by detecting the absence of backscattered infrared light.

The abovementioned prior arts are based on the well-known scientific fact that the near infrared light (NIR) absorption rate of hemoglobin is the highest out of the elements of blood. That is, when human skin is irradiated by NIR, a larger amount of NIR is absorbed by the skin beneath which a vein exists than by the skin beneath which a vein does not exist. Therefore, the prior arts utilize the fact that an area of the skin beneath which a vein exists appears darker than an area of the skin beneath which a vein does not exist.

Medical apparatuses for visualizing veins are recently commercialized, which use the abovementioned method for acquiring vein images. The apparatuses commercialized as an apparatus for verification or identification of an individual based on the fact that no vein pattern of a back and palm of the hand, and fingers is identical to another.

The conventional apparatuses for visualizing veins are operated without contacting skin. However, there is a disadvantage that it is necessary to adjust manually an amount of NIR of an NIR illuminator according to an illuminance of surroundings, a distance from a subject to be visualized, a skin color of the subject to be visualized, etc.

Also, person recognition apparatuses of the conventional apparatuses utilizing vein images, has a disadvantage that a image aquisition part should be made contact with skin of the back and palm of the hand, and a finger in order to exclude the influence of the illuminance of the surroundings and a distance from a subject. In addition, the person recognition apparatuses has a disadvantage that it is necessary to process the acquisited images, e.g., to correct the influences of hairs, scars, flecks, pigmented spots and skin colors on the skin of the subject, in order to extract exact vein patterns.

Further, the conventional apparatus for recognizing vein patterns has a disadvantage that the apparatus does not acquire images of vein which exists deep under the skin.

### DISCLOSURE OF INVENTION

### Technical Problem

The primary object of the present invention is to provide an apparatus for recognizing a subcutaneous vein pattern comprising: a light illuminator having an NIR (near infrared light) emitting device; an image acquisitor having a lenz and an image sensor which converts light reflected from subcutaneous vein into an image signal; a microprocessor which adjusts an illuminating intensity of the light illuminator and a light receiving sensitivity of the image acquisitor according to an illuminance estimated from the image signal; and a displayer which display image signals received from the microprocessor.

Another object of the present invention is to provide an apparatus for recognizing a subcutaneous vein pattern for user identification comprising: a data base in which a subcutaneous vein pattern is stored; a light illuminator having an NIR light emitting device; an image acquisitor having a lenz and an image sensor which converts light reflected from a skin and a hypodermic tissue into an image signal; and a microprocessor which adjusts an illuminating intensity of said light illuminator and a light receiving sensitivity of said image acquisitor according to an illuminance estimated from the image signal which said image acquisitor obtain, and identifies said user by comparing said image signal with a subcutaneous vein pattern stored in said data base.

Yet another object of the present invention is to provide an apparatus for recognizing a face comprising: a data base in which image data for a face are stored; a light illuminator having an NIR light emitting device and a visible light emitting device; an image acquisitor having a lenz and an image sensor which converts light reflected from a face skin and a hypodermic tissue into an image signal; and a microprocessor which adjusts an illuminating intensity of said light illuminator and a light receiving sensitivity of said image acquisitor according to an illuminance estimated from the image signal, and identifies a user by comparing said image signal with image data for a face stored in said data base.

Still another object of the present invention is to provide a method for recognizing a subcutaneous vein pattern comprising: i) illuminating skin with NIR; ii) converting NIR reflected from skin and a hypodermic tissue, into image signal by using an image sensor; iii) adjusting an illuminating intensity of the NIR or a light receiving sensitivity of said image sensor, according to an illuminance estimated from the image signal; and iv) converting reflected NIR after illuminating the skin with NIR of which illuminating intensity was adjusted at said step iii) into image signal by using said image sensor, or obtaining an image signal by using said image sensor of which the light receiving intensity was adjusted.

Further another object of the present invention is to provide a method for recognizing a subcutaneous vein pattern comprising: i) illuminating skin with NIR and visible light; ii) converting NIR and visible light reflected from skin and a hypodermic tissue, into image signal by using an image sensor; iii) adjusting an illuminating intensity of the NIR and visible light, or a light receiving sensitivity of said image sensor according to an illuminance estimated from the image signal; iv) converting reflected NIR and visible light after illuminating the skin with NIR and visible light of which illuminating intensity were adjusted at said step iii) into image signal by using said image sensor, or obtaining an image signal by using said image sensor of which the light receiving intensity was adjusted; and v) generating a subcutaneous vein pattern image by comparing the image signal obtained from visible light with the image signal obtained from NIR.

### Technical Solution

The primary object of the present invention can be achieved by providing an apparatus for recognizing a subcutaneous vein pattern comprising: a light illuminator having an NIR (near infrared light) emitting device; an image acquisitor having a lenz and an image sensor which converts light reflected from subcutaneous vein into an image signal; a microprocessor which adjusts an illuminating intensity of the light illuminator and a light receiving sensitivity of the image acquisitor according to an illuminance estimated from the image signal; and a displayer which display image signals received from the microprocessor.

The displayer may be selected from the group consisting of an LCD (a liquid crystal display), an OLED (an organic light-emitting diode), a PDP (a plasma display panel) and a CRT (a cathode ray tube).

The illuminance may be measured by an illuminance sensor installed in the apparatus.

The light illuminator comprises a diffuser and a linear polarizing filter to irradiate an NIR uniformly to the skin.

The image acquisitor may comprise a linear polarizing filter and the linear polarizing filter of the image aquisitor may be installed perpendicular to said linear polarizing filter installed in the light illuminator. Also, the image acquisitor may comprise an NIR filter. Preferably, a liquid crystal panel may be used as the NIR filter.

The conventional NIR light emitting device may be used as the NIR light emitting device, and preferably an LED may be used.

Preferably, the image sensor is a semiconductor image sensor such as a CMOS (complementary metal-oxide semiconductor) sensor or a CCD (charge-coupled device) sensor.

The light illuminator may further comprise a visible light emitting device.

Preferably, the displayer is located on the opposite side of said image acquisitor.

The LCD used for the NIR filter is mostly made of a nematic liquid crystal and most of the LCD is based on a twisted nematic structure. The LCD operates in the way that an electrical potential is applied to a liquid crystal to become an orthogonal polarization state compared to the polarizer on the surface of the LCD panel, and then the transmission of visible light is minimized. When the liquid crystal is made to become a parallel polarization state compared to the polarizer on the surface of the LCD panel, the transmission of visible light is maximized. Usually, a polarizer used for a liquid crystal panel is manufactured by having iodine or a dichromatic dye be adsorbed onto a PVA film. Although the transmission of a visible light is minimized in the orthogonal polarization state, NIR is transmitted in such state.

According the the present invention, the liquid crystal panel is located at front end of the image aquisitor and either NIR images or visible-light images can be obtained by adjusting the electrical potential which is applied to the liquid crystal through the microprocessor.

When the NIR images are required, the microprocessor adjusts the electrical potential which is applied to the liquid crystal, to make the liquid crystal become a orthgonal polarization state compared to the polarizer, which allows only NIR to be transmitted. Also, when only the visible-light images are required, the liquid crystal is made to become parallel polarization state compared to the polarizer.

When the LCD NIR filter is used, images from which the influences of hairs, scars, flecks, pigmented spots and skin colors on the skin of the subject are corrected, can be easily obtained through the visible-light and infrared images of the skin.

In other words, the optimum NIR images of the skin may be obtained by adjusting the strength of the NIR according to the skin color or pigmented spots of the visible-light images, and images of a vein pattern, from which the hairs, scars, flecks, etc. of the skin are removed, can be easily obtained by extracting the images which appear in the NIR images of the skin but not in the visible-light images of the skin. Also, a face recognition function can be added to the apparatus for recognizing a subcutaneous vein pattern since the apparatus can be utilized as an common visible-light imaging apparatus by using the LCD NIR filter.

When linearly polarized NIR is irradiated to the skin by using a linear polarizing filter installed at the front end of the light illuminator, the linearly polarized NIR is less scattered by the subcutaneous tissues, etc. than a non-polarized NIR. Therefore, the linearly polarized NIR can reach veins which exist deep under the skin.

Also, a linear polarizing filter may be installed at the front end of the image acquisitor at an angle of 90 degrees to the linear polarizing filter of the light illuminator.

The amount of irradiation of NIR must be increased so that the linearly polarized NIR irradiated from the light illuminator may reach deep under the skin and be reflected therefrom. However, the more the amount of the irradiation of NIR, the more the amount of the reflected NIR. It is advantageous to obtain the NIR reflected from the subcutaneous veins without including NIR reflected from the surface of the skin in order to obtain effectively images of the subcutaneous vein pattern.

When the linear polarized NIR from the light illuminator is irradiated to the skin, the NIR reflected from the surface of the skin reach the linear polarizing filter at the front end of the image aquisitor without changing its direction of polarization. At this moment, the NIR reflected from the surface of the skin cannot reach the image acquisitor since the linear polarizing filter mounted at the front end of the image acquisitor is installed in the state of the orthogonal polarization compared to the linear polarizing filter of the light illuminator. To the contrary, the linearly polarized NIR which penetrates under the skin reflects with its direction of polarization changed, and then reach the image acquisitor through the linear polarizing filter.

Another object of the present invention can be achieved by providing an apparatus for recognizing a subcutaneous vein pattern for user identification comprising: a data base in which a subcutaneous vein pattern is stored; a light illuminator having an NIR light emitting device; an image acquisitor having a lenz and an image sensor which converts light reflected from a skin and a hypodermic tissue into an image signal; and a microprocessor which adjusts an illuminating intensity of said light illuminator and a light receiving sensitivity of said image acquisitor according to an illuminance estimated from the image signal which said image acquisitor obtain, and identifies said user by comparing said image signal with a subcutaneous vein pattern stored in said data base.

The illuminance may be measured by an illuminance sensor installed in the apparatus.

The light illuminator comprises a diffuser and a linear polarizing filter to irradiate an NIR uniformly to the skin.

The image acquisitor may comprise a linear polarizing filter and the linear polarizing filter of the image aquisitor may be installed perpendicular to said linear polarizing filter installed in the light illuminator. Also, the image acquisitor may comprise an NIR filter. Preferably, a liquid crystal panel may be used as the NIR filter.

The conventional NIR light emitting device may be used as the NIR light emitting device, and preferably an LED may be used.

Preferably, the image sensor is a semiconductor image sensor such as a CMOS sensor or a CCD sensor.

The light illuminator may further comprise a visible light emitting device.

Yet another object of the present invention can be achieved by providing an apparatus for recognizing a face comprising: a data base in which image data for a face are stored; a light illuminator having an NIR light emitting device and a visible light emitting device; an image acquisitor having a lenz and an image sensor which converts light reflected from a face skin and a hypodermic tissue into an image signal; and a microprocessor which adjusts an illuminating intensity of said light illuminator and a light receiving sensitivity of said image acquisitor according to an illuminance estimated from the image signal, and identifies a user by comparing said image signal with image data for a face stored in said data base.

The illuminance may be measured by an illuminance sensor installed in the apparatus.

The light illuminator comprises a diffuser and a linear polarizing filter to irradiate an NIR uniformly to the skin.

The image acquisitor may comprise a linear polarizing filter and the linear polarizing filter of the image aquisitor may be installed perpendicular to said linear polarizing filter installed in the light illuminator. Also, the image acquisitor may comprise an NIR filter. Preferably, a liquid crystal panel may be used as the NIR filter.

The conventional NIR light emitting device may be used as the NIR light emitting device, and preferably an LED may be used.

Preferably, the image sensor is a semiconductor image sensor such as a CMOS sensor or a CCD sensor.

The light illuminator may further comprise a visible light emitting device.

Still another object of the present invention can be achieved by providing a method for recognizing a subcutaneous vein pattern comprising: i) illuminating skin with NIR; ii) converting NIR reflected from skin and a hypodermic tissue, into image signal by using an image sensor; iii) adjusting an illuminating intensity of the NIR or a light receiving sensitivity of said image sensor, according to an illuminance estimated from the image signal; and iv) converting reflected NIR after illuminating the skin with NIR of which illuminating intensity was adjusted at said step iii) into image signal by using said image sensor, or obtaining an image signal by using said image sensor of which the light receiving intensity was adjusted.

The illuminance may be measured by an illuminance sensor installed in the apparatus.

The conventional NIR light emitting device may be used as the NIR light emitting device, and preferably an LED may be used.

Preferably, the image sensor is a semiconductor image sensor such as a CMOS sensor or a CCD sensor.

Further another object of the present invention can be achieved by providing a method for recognizing a subcutaneous vein pattern comprising: i) illuminating skin with NIR and visible light; ii) converting NIR and visible light reflected from skin and a hypodermic tissue, into image signal by using an image sensor; iii) adjusting an illuminating intensity of the NIR and visible light, or a light receiving sensitivity of said image sensor according to an illuminance estimated from the image signal; iv) converting reflected NIR and visible light after illuminating the skin with NIR and visible light of which illuminating intensity were adjusted at said step iii) into image signal by using said image sensor, or obtaining an image signal by using said image sensor of which the light receiving intensity was adjusted; and v) generating a subcutaneous vein pattern image by comparing the image signal obtained from visible light with the image signal obtained from NIR.

The above method may further comprise: vi) adjusting an illuminating intensity of the NIR, or a light receiving sensitivity of said image sensor according to a skin condition learned from the image signal obtained from the reflected visible light in step iv); and vii) converting reflected NIR after illuminating the skin with NIR of which illuminating intensity was adjusted at said step vi) into image signal by using said image sensor, or obtaining an image signal by using said image sensor of which the light receiving intensity was adjusted.

The illuminance may be measured by an illuminance sensor installed in the apparatus.

The conventional NIR light emitting device may be used as the NIR light emitting device, and preferably an LED may be used.

Preferably, the image sensor is a semiconductor image sensor such as a CMOS sensor or a CCD sensor.

### Advantageous Effects

As mentioned above, by using the apparatus and the method of the present invention, a subcutaneous vein pattern can be easily recognized. Therefore, the position of intravenous insertion can be determined easily by finding exactly the location of veins in real-time. Also, the apparatus of the present invention can be applied to a security system such as an access control system using the vein pattern.

### BRIEF DESCRIPTION OF THE DRAWINGS

FIG. 1 is a schematic diagram of the apparatus for recognizing a vein pattern, according to the present invention.

FIG. 2 is a preferable embodiment of the apparatus for recognizing a vein pattern, according to the present invention.

### BEST MODE FOR CARRYING OUT THE INVENTION

Hereinafter, the present invention will be described in greater detail with reference to the following embodiments and drawings. However, the embodiments and drawings are given only for illustration of the present invention and not to be limiting the present invention.

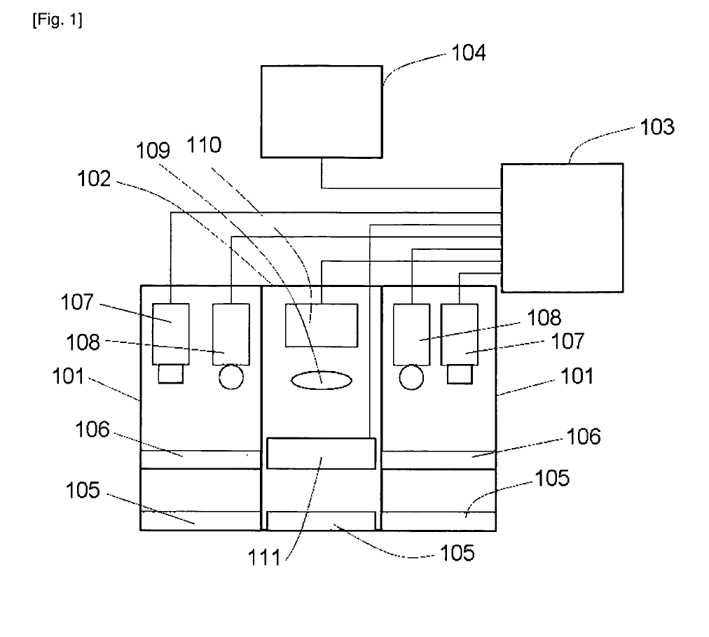

Referring to FIG. 1, a schematic diagram of the apparatus for recognizing a subcutaneous vein pattern according to the present invention is represented.

The NIR illuminator 101 comprises an NIR emitting device 107, a diffuser 106, and optionally a linear polarizing filter 105. A light-emitting diode may be preferably used as the NIR emitting device 107, and other NIR light sources may also be used. The irradiated NIR is uniformly irradiated to the skin by the diffuser 106. The NIR scattered by the diffuser 106 can be polarized by using a linear polarizing filter.

When the irradiated NIR reach the skin, a part of the NIR is reflected on the surface of the skin and a part of the NIR penetrates under the skin. The penetrated NIR is reflected or absorbed by subcutaneous tissues and more NIR is absorbed by veins than by other tissues. Therefore, the veins appear dark in the image of the image acquisitor 102 since the amount of NIR reflected by the veins is more than that of NIR reflected by other tissues.

At this time, when the amount of NIR irradiated to the skin is too much, shadings of the acquired image cannot be distinguished since the amount of NIR reflected by the surface of the skin is so much. Also, when the amount of NIR irradiated to the skin is too little, shadings of the acquired image cannot be distinguished since the amount of NIR reflected by the surface of the skin is so little.

According to the present invention, after adjusting the illuminating intensity of the NIR illuminator 101 or the light receiving sensitivity of the image sensor 110 based on the illuminance estimated, by the microprocessor 103, from the acquired image signals or the illuminance measured by a NIR illuminance sensor, the image signals of the NIR reflected by the skin or subcutaneous tissues is obtained based on the adjusted illuminating intensity of the NIR or the adjusted light receiving sensitivity. The above steps are repeated to obtain the optimum images.

The image acquisitor 102 comprises a image sensor 110, a lenz 109, optionally an NIR filter 111, and optionally a linear polarizing filter 105.

The image sensor 110 is a semiconductor image sensor such as a CMOS sensor or a CCD sensor. The NIR filter 111 which blocks visible light and transmits NIR is mounted between the image sensor 110 and the lenz 109, or in front of the lenz 109. It is preferable to use a liquid crystal panel as the NIR filter 111.

When the NIR filter made of the liquid crystal panel is mounted on the image acquisitor 102, only NIR or NIR with visible light can be transmitted by adjusting, via the microprocessor 103, the electrical potential applied to the liquid crystal. Therefore, the NIR images and the visible-light images can be obtained. When obtaining the visible-light images, the microprocessor 103 adjusts the illuminating intensity of the light illuminator 101 according to the illuminance of the surroundings so as to obtain the optimum visible-light images. The optimum illuminating intensity of the visible light illuminator 101 is determined by analysing the acquired visible-light images or by the illuminance measured by the visible light illuminance sensor.

The light source of the visible light illuminator 101 is preferably a visible light LED and other light sources can be used.

Once the optimum NIR image and the optimum visible-light image are obtained, the two images are analyzed and compared with each other to give the image from which the influences of hairs, scars, flecks, pigmented spots and skin colors on the skin of the subject are corrected.

Optionally, the NIR images obtained from the image acquisitor 102 can also be displayed in real-time on the displayer 104 by using the microprocessor 103, and therefore the shape and location of the veins can be visualized.

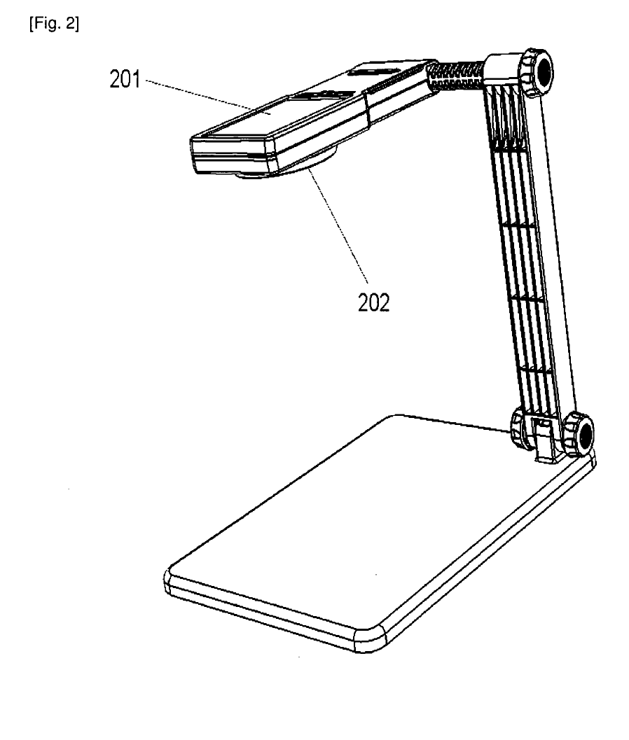

Preferably, flat panel displays such as an LCD, an OLED, a PDP, etc. are used as the displayer 104. When the image acquisitor 102, 202 is located in the middle of the opposite side of the displayer 104, 201 (refer to FIG. 2), vein-associated treatments such as an intravenous injection, a vein laser operation, etc. can be easily performed with the observation of the vein images visualized in real-time.

Referring now to FIG. 2, a preferable embodiment of the apparatus for recognizing a vein pattern, according to the present invention, is represented. As can be seen from FIG. 2, the apparatus of the present invention can be manufactured as a portable apparatus.

1. An apparatus for recognizing a subcutaneous vein pattern comprising:
a light illuminator having an NIR (near infrared light) emitting device;
an image acquisitor having a lenz and an image sensor which converts light reflected from subcutaneous vein into an image signal;
a microprocessor which adjusts an illuminating intensity of the light illuminator and a light receiving sensitivity of the image acquisitor according to an illuminance estimated from the image signal; and
a displayer which display image signals received from the microprocessor.

2. The apparatus of claim 1, wherein said displayer is selected from the group consisting of an LCD, an OLED, a PDP and a CRT.

3. The apparatus of claim 1, wherein said light illuminator comprises a diffuser and a linear polarizing filter.

4. The apparatus of claim 1, wherein said image acquisitor comprises a linear polarizing filter.

5. The apparatus of claim 4, wherein said linear polarizing filter of said image aquisitor is installed perpendicular to said linear polarizing filter installed in said light illuminator.

6. The apparatus of claim 1, wherein said image acquisitor comprises an NIR filter.

7. The apparatus of claim 6, wherein said NIR filter is a liquid crystal panel.

8. The apparatus of claim 1, wherein said NIR light emitting device is an LED.

9. The apparatus of claim 1 wherein said image sensor is a CMOS sensor or a CCD sensor.

10. The apparatus of claim 1, wherein said light illuminator further comprises a visible light emitting device.

11. The apparatus of claim 1, wherein said displayer is located on the opposite side of said image acquisitor.

12. An apparatus for recognizing a subcutaneous vein pattern for user identification comprising:
a data base in which a subcutaneous vein pattern is stored;
a light illuminator having an NIR light emitting device;
an image acquisitor having a lenz and an image sensor which converts light reflected from a skin and a hypodermic tissue into an image signal; and
a microprocessor which adjusts an illuminating intensity of said light illuminator and a light receiving sensitivity of said image acquisitor according to an illuminance estimated from the image signal which said image acquisitor obtain, and identifies said user by comparing said image signal with a subcutaneous vein pattern stored in said data base.

13. The apparatus of claim 12, wherein said NIR light emitting device is an LED.

14. The apparatus of claim 12, wherein said light illuminator comprises a diffuser and a linear polarizing filter.

15. The apparatus of claim 14, wherein said light illuminator comprises a linear polarizing filter.

16. The apparatus of claim 15, wherein said linear polarizing filter of said image acquisitor is installed perpendicular to a linear polarizing filter installed in said light illuminator.

17. The apparatus of claim 12, wherein said image acquisitor comprises an NIR filter.

18. The apparatus of claim 17, wherein said NIR filter is a liquid crystal panel.

19. The apparatus of claim 12, wherein said image sensor is a CMOS sensor or a CCD sensor.

20. The apparatus of claim 12, wherein said light illuminator further comprises a visible light emitting device.

21. An apparatus for recognizing a face comprising:
a data base in which image data for a face are stored;
a light illuminator having an NIR light emitting device and a visible light emitting device;
an image acquisitor having a lenz and an image sensor which converts light reflected from a face skin and a hypodermic tissue into an image signal; and
a microprocessor which adjusts an illuminating intensity of said light illuminator and a light receiving sensitivity of said image acquisitor according to an illuminance estimated from the image signal, and identifies a user by comparing said image signal with image data for a face stored in said data base.

22. The apparatus of claim 21, wherein said light illuminator comprises a diffuser and a linear polarizing filter.

23. The apparatus of claim 21, wherein said image acquisitor comprises a linear polarizing filter.

24. The apparatus of claim 23, wherein said linear polarizing filter of said image acquisitor is installed perpendicular to a linear polarizing filter installed in said light illuminator.

25. The apparatus of claim 21, wherein said image acquisitor comprises an NIR filter.

26. The apparatus of claim 25, wherein said NIR filter is a liquid crystal panel.

27. The apparatus of claim 21, wherein said NIR light emitting device and a visible light emitting device are LEDs.

28. The apparatus of claim 21, wherein said image sensor is a CMOS sensor or a CCD sensor.

29. A method for recognizing a subcutaneous vein pattern comprising:
i) illuminating skin with NIR;
ii) converting NIR reflected from skin and a hypodermic tissue, into image signal by using an image sensor;
iii) adjusting an illuminating intensity of the NIR or a light receiving sensitivity of said image sensor, according to an illuminance estimated from the image signal; and
iv) converting reflected NIR after illuminating the skin with NIR of which illuminating intensity was adjusted at said step iii) into image signal by using said image sensor, or obtaining an image signal by using said image sensor of which the light receiving intensity was adjusted.

30. A method for recognizing a subcutaneous vein pattern comprising:
i) illuminating skin with NIR and visible light;
ii) converting NIR and visible light reflected from skin and a hypodermic tissue, into image signal by using an image sensor;
iii) adjusting an illuminating intensity of the NIR and visible light, or a light receiving sensitivity of said image sensor according to an illuminance estimated from the image signal;
iv) converting reflected NIR and visible light after illuminating the skin with NIR and visible light of which illuminating intensity were adjusted at said step iii) into image signal by using said image sensor, or obtaining an image signal by using said image sensor of which the light receiving intensity was adjusted; and
v) generating a subcutaneous vein pattern image by comparing the image signal obtained from visible light with the image signal obtained from NIR.

31. The method of claim 30 which further comprises:
vi) adjusting an illuminating intensity of the NIR, or a light receiving sensitivity of said image sensor according to a skin condition learned from the image signal obtained from the reflected visible light in step iv); and
vii) converting reflected NIR after illuminating the skin with NIR of which illuminating intensity was adjusted at said step vi) into image signal by using said image sensor, or obtaining an image signal by using said image sensor of which the light receiving intensity was adjusted.
